(19) United States
(12) Patent Application Publication
(10) Pub. No.: US 2008/0072073 A1
(43) Pub. Date: Mar. 20, 2008

(54) PORTABLE STORAGE DEVICE WITH ENCRYPTION PROTECTION

(75) Inventor: Cheng-chih Yang, Taipei City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/856,875

(22) Filed: Sep. 18, 2007

(30) Foreign Application Priority Data
Sep. 18, 2006 (TW) 095216587

(51) Int. Cl. G06F 12/14

(52) U.S. Cl. 713/193

(57) ABSTRACT

A portable storage device with encryption protection is provided, including a memory interface connected to a data access host for inputting decryption information from the data access host and for outputting to the data access host, an encryption promotion unit connected to the memory interface for recording the data protection status, at least an encryption control unit connected to the encryption promotion unit for identifying data encryption code or signal, and issuing enabling or disabling control signal, a protection gate unit connected to the encryption control unit and the memory interface for enabling or disabling the data transmission to the memory interface according to the control signal from encryption control unit, and at least a protected data region and invalid data region connected to protection gate unit for the protected data region to output data to data access host when protection gate unit being enabled, and for invalid data region to output invalid data to data access host when protection gate unit being disabled, so that the portable storage device can achieve the objects of accurate and permanently effective encryption.

### BACKGROUND OF THE INVENTION

1. Field of the Invention

The present invention relates to a portable storage device with encryption protection and, more particularly, to a portable storage device with encryption to protect unauthorized access.

2. The Related Arts

Flash memory is widely used in many types of digital equipment, such as flash memory sticks, and MP3 players. However, conventional flash memory sticks and MP3 players do not provide any data security protection so that the data stored in the flash memory in these devices are prone to exposure to authorized access. For example, if the flash memory sticks and MP3 players are stolen or misplaced, the data may be subjected to public access, which may lead to further financial or privacy damage.

Taiwan Patent Publication No. 200604958 disclosed a flash memory stick with encryption device, which uses encryption pairing or encryption key to provide encryption protection. However, this type of memory stick is constrained by the use of instant messaging or similar platform on Internet. This approach does not provide stand-alone encryption operation and protection.

Taiwan Patent Publication No. M288421 disclosed a portable storage device with highly encrypted security, which includes the use of bio-feature identification, such as fingerprint identification. Although the disclosed device is provided with bio-feature identification to prevent against unauthorized access, there are several disadvantages, including the need of a portable bio-feature sensor and a microprocessor to process the identification, resulting in the cost of the portable storage device. In addition, the bio-feature sensor is usually on the outer surface of the portable storage device for collecting bio-features, and thus may accumulate dust or other contamination to cause misidentification of the bio-features. All these may lead to the loss of data permanently.

### SUMMARY OF THE INVENTION

An object of the present invention is to provide a portable storage device with encryption protection for providing data access hosts and storage device with accurate and effective mechanism.

Another object of the present invention is to provide a portable storage device with encryption protection, including outputting invalid data when identification failure or mal-function so that the user can differentiate identification failure or malfunction of the device.

Yet another object of the present invention is to provide a portable storage device with encryption protection without the use of expensive bio-feature identification sensor and microprocessor, so as to reduce the manufacturing cost and prolong the encryption effectiveness life span.

To achieve the above objects, the present invention provides a portable storage device with encryption protection, including a memory interface connected to a data access host, for inputting decryption information from the data access host and for outputting to data access host, an encryption promotion unit connected to the memory interface for recording the data protection status, at least an encryption control unit connected to the encryption promotion unit for identifying data encryption code or signal, and issuing enabling or disabling control signal, a protection gate unit connected to the encryption control unit and the memory interface for enabling or disabling the data transmission to the memory interface according to the control signal from encryption control unit, and at least a protected data region and invalid data region connected to protection gate unit, for the protected data region to output data to data access host when protection gate unit being enabled, and for invalid data region to output invalid data to data access host when protection gate unit being disabled, so that the portable storage device can achieve the objects of accurate and permanently effective encryption.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention will be apparent to those skilled in the art by reading the following description of preferred embodiments thereof, with reference to the attached drawings, wherein:

FIG. 1 shows a first embodiment of a portable storage device with encryption protection in accordance with the present invention; and

FIG. 2 shows a second embodiment of a portable storage device with encryption protection in accordance with the present invention.

### DETAILED DESCRIPTION OF THE PREFERRED EMBODIMENTS OF THE PRESENT INVENTION

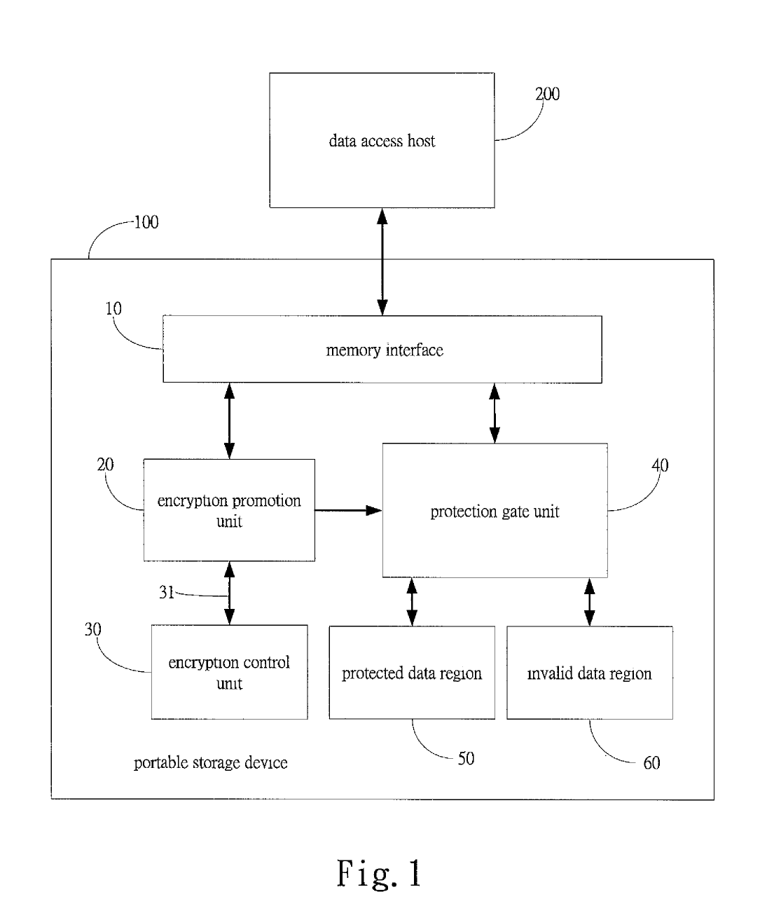

With reference to the drawings and in particular to FIG. 1, which shows a portable storage device with encryption protection constructed in accordance with a first embodiment of the present invention, generally designated with reference numeral 100, the portable storage device 100 comprises a memory interface 10, an encryption promotion unit 20, at least an encryption control unit 30, a protection gate unit 40, and at least a protected data region 50 and invalid data region 60. The memory interface 10 is connected to a data access host 200. The data access host 200 is not limited to any specific type. The present embodiment uses a PC for illustration. Other equivalent types of data access hosts are also within the scope of the present invention. The data access host 200 inputs decryption information through the memory interface 10 to the portable storage device 100, and the portable storage device 100 outputs stored data through the memory interface 10 to the data access host 200. The decryption information of the data access host 200 can be pre-stored in the encryption program of the data access host 200, or generated by application software.

The encryption promotion unit 20 is connected to the memory interface 10 for recording data protection status; that is, the process and the status of confirming the decryption information of the data access host 200.

The encryption control unit 30 is connected to the encryption promotion unit 20, for receiving the decryption information from the data access host 200 and for encryption identification. The decryption data, such as the decryption key or identification program can be pre-stored in the encryption control unit 30, and the identification process is automatically activated when decryption information arrives. The identification result and the status are stored in the encryption promotion unit 20. The encryption control unit 30 issues an enabling or disabling control signal 31 to the encryption promotion unit 20 based on the identification result.

The protection gate unit 40 is connected to the memory interface 10 and the encryption promotion unit 20. The protection gate unit 40 enables or disables the data transmission between a portable storage device and the data access device 200 according to the control signal 31 from the encryption promotion unit 20.

The protected data region 50 and the invalid data region 60 are connected to and controlled by the protection gate unit 40. The protected data region 50 stores the protected data, and the invalid data region 60 stores random numbers, warning messages, and other invalid information. The protection gate unit 40 determines the enabling or disabling of the protected data region 50 and the invalid data region 60 based on the enabling or disabling status of the control signal 31. For example, when the identification is confirmed, the protection gate unit 40 is enabled, and the data stored in the protected data region 50 is outputted through the protection gate unit 40, the memory interface 10 to the data access host 200, while the invalid data region 60 is disabled.

On the other hand, when the encryption control unit 30 could not identify to confirm the decryption information from the data access host 200, the protection gate unit 40 is disabled. Hence, the protected data region 50 will not output any data to the data access host 200, while the invalid data region 60 is enabled and outputs random number, warning message or other invalid information through the protection gate unit 40 and the memory interface 10 to the data access host 200. Therefore, what the data access host 200 receives is the invalid data when the decryption information is incorrect. Thus, the data security is protected.

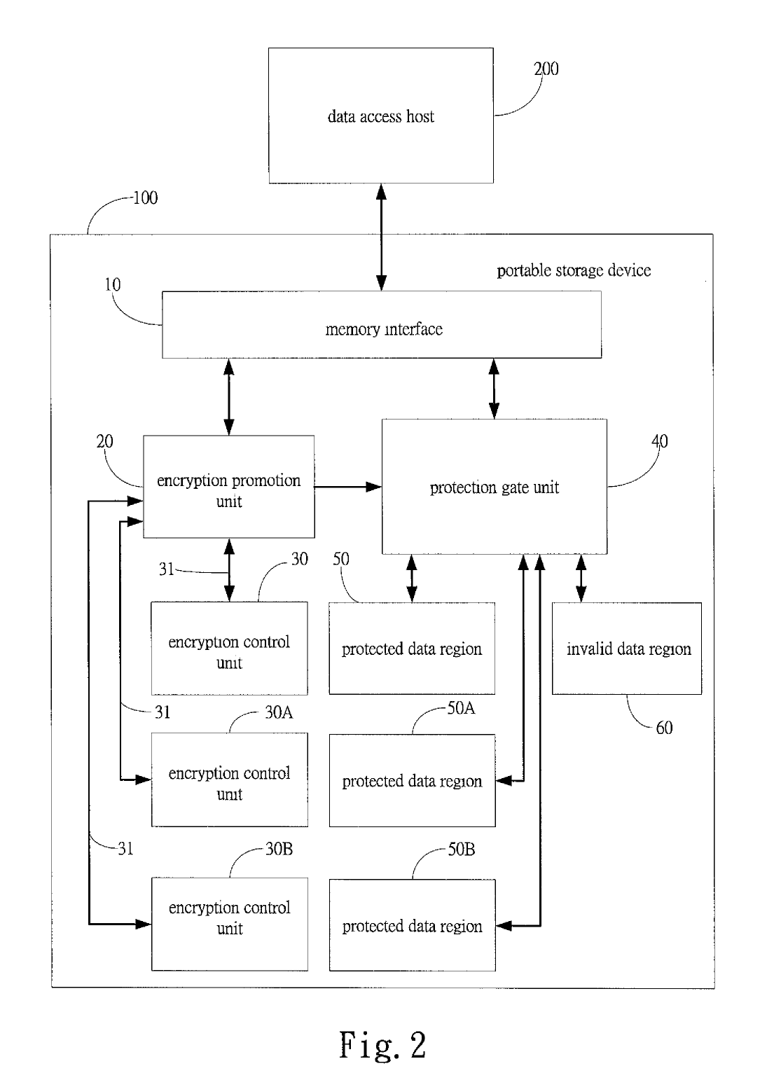

FIG. 2 shows a portable storage device with encryption protection, also designated with reference numeral 100, constructed in accordance with a second embodiment of the present invention, including a plurality of encryption control units 30, 30A, 30B and a plurality of protected data regions 50, 50A, 50B. The encryption control unit 30 corresponds to the protected data region 50, the encryption control unit 30A corresponds to the protected data region 50A, and the encryption control unit 30B corresponds to the protected data region 50B. In other words, each protected data region has its own encryption key or information. When each protected data region 50, 50A, 50B has separate encryption key or information, the protected data stored in each protected data region 50, 50A, 50B can only be accessed through the provision of the correct corresponding encryption key or information. This provides more flexibility in protection management.

While the invention has been described in connection with what is presently considered to the most practical and preferred embodiments, it is to be understood that the invention is not to be limited to the disclosed embodiment, but on the contrary, is intended to cover various modifications and equivalent arrangement included within the spirit and scope of the appended claims.

What is claimed is:

1. A portable storage device with encryption protection, comprising:
a memory interface, connected to a data access host for inputting decryption information from the data access host and for outputting data to the data access host;
an encryption promotion unit, connected to the memory interface for recording the data protection status, including process and status of identifying decryption information from the data access host;
at least an encryption control unit, connected to the encryption promotion unit for identifying decryption information from the data access host, storing the identification result and status to the encryption promotion unit, and issuing an enabling or disabling control signal to the encryption promotion unit based on the identification result;
a protection gate unit, connected to the encryption control unit and the memory interface for enabling or disabling the data transmission to the data access host through the memory interface according to the control signal from the encryption control unit; and
at least a protected data region and an invalid data region, connected to and controlled by the protection gate unit, for the protected data region through the protection gate unit and the memory interface to output data to the data access host when the protection gate unit is enabled, and for the invalid data region to output invalid data through the protection gate unit and the memory interface to the data access host when the protection gate unit is disabled.

2. The portable storage device as claimed in claim 1, wherein the encryption control unit pre-stores identification information.

3. The portable storage device as claimed in claim 2, wherein the identification information is a decryption key.

4. The portable storage device as claimed in claim 2, wherein the identification information is an identification program.

5. The portable storage device as claimed in claim 1, wherein the identification information is an identification program.

6. The portable storage device as claimed in claim 1, wherein the invalid data in the invalid data region is random number.

7. The portable storage device as claimed in claim 1, wherein the invalid data in the invalid data region is warning messages.
